(19) United States
(12) Patent Application Publication
(10) Pub. No.: US 2012/0056843 A1
(43) Pub. Date: Mar. 8, 2012

(54) RESISTIVE TOUCH PANEL

(75) Inventors: Jae Il Kim, Gyunggi-do (KR); Yong Soo Oh, Gyunggi-do (KR); Jong Young Lee, Gyunggi-do (KR); Woon Chun Kim, Gyunggi-do (KR); Hyun Jun Kim, Gyunggi-do (KR)

(73) Assignee: SAMSUNG ELECTRO-MECHANICS CO., LTD., Gyunggi-do (KR)

(21) Appl. No.: 12/965,612

(22) Filed: Dec. 10, 2010

(30) Foreign Application Priority Data
Sep. 3, 2010 (KR) 1020100086652

(51) Int. Cl. G06F 3/045

(52) U.S. Cl. 345/174

(57) ABSTRACT

Disclosed herein is a resistive touch panel, including: a transparent substrate; a transparent electrode formed on the transparent substrate and including a conductive polymer; and a curing agent applied to the transparent electrode, the curing agent undergoing a hydrolysis reaction with the conductive polymer to cure the transparent electrode. The resistive touch panel is advantageous in that, even when a transparent electrode is formed using a conductive polymer having low hardness, the hardness of the transparent electrode is improved by the application of the curing agent, so that it is possible to prevent the contact resistance between the transparent electrodes facing each other from changing in relation to the pressure intensity of input means, thereby improving the touch sensitivity and performance of the resistive touch panel.

### CROSS REFERENCE TO RELATED APPLICATION

This application claims the benefit of Korean Patent Application No. 10-2010-0086652, filed Sep. 3, 2010, entitled “Resistive type touch screen”, which is hereby incorporated by reference in its entirety into this application.

### BACKGROUND OF THE INVENTION

1. Technical Field

The present invention relates to a resistive touch panel.

2. Description of the Related Art

Development of auxiliary computer devices has taken place alongside the advancement of computers which use digital technology. Personal computers, portable transmitters, and other personal information processing apparatuses carry out the processing of text and graphics using input devices such as keyboards, mice and the like.

However, since computers are gradually being used for various purposes at the same time as the information society is rapidly advancing, there is a problem in that it is difficult to efficiently operate the computers using keyboards and mice as the input devices. Therefore, the demand to develop an input device which has a simple structure and does not cause erroneous operations and which can be used by users to easily input information and data is increasing.

Further, input devices must have high reliability, high durability, high innovativeness and high workability in addition to general functionality. In order to accomplish these purposes, a touch panel was developed as an input device capable of inputting information such as text, graphics and the like.

The touch panel is mounted on image display apparatuses, such as flat panel displays including electronic notebooks, liquid crystal displays (LCDs), plasma display panels (PDPs), electroluminescence panels, etc., and cathode ray tubes (CRTs), and is used to enable users to select desired information while viewing an image display apparatus.

Touch panels are classified into resistive touch panels, capacitive touch panels, electromagnetic touch panels, surface acoustic wave (SAW) type touch panels, and infrared touch panels. These various types of touch panels are employed in electronic products in consideration of the problem of signal amplification, the differences of resolution, the difficulty in design and machining techniques, optical characteristics, electrical characteristics, mechanical characteristics, environment-resistant characteristics, input characteristics, durability, and economical efficiency. Currently, among these touch panels, resistive touch panels are the most widely used.

Meanwhile, a touch panel is provided with a transparent electrode in order to recognize touch coordinates. Conventionally, indium tin oxide (ITO) has been most widely used to make a transparent electrode. However, when a transparent electrode is formed using indium tin oxide (ITO), there are problems in that the manufacturing cost thereof excessively increases, the supply of indium is insufficient because indium is available in a limited supply, and the transparent electrode may crack.

In order to solve the above problems, various research attempts have been made to find alternatives to indium tin oxide (ITO). Among the alternatives, a conductive polymer is advantageous in that, when a transparent electrode is made of the conductive polymer, the cost of manufacturing the transparent electrode can be reduced, and the possibility of allowing the transparent electrode to crack is relatively low compared to when the transparent electrode is made of other alternatives. However, the conductive polymer is problematic in that, when a transparent electrode is made of the conductive polymer, the hardness of the transparent electrode is relatively low compared to when the transparent electrode is made of other alternatives. Therefore, in the case of a resistive touch panel which is operated by bringing two transparent electrodes facing each other into contact with each other, when the transparent electrodes are made of a conductive polymer, there is a problem in that the contact resistance between the two transparent electrodes changes depending on the pressure intensity of input means, thus deteriorating the touch sensitivity and performance of a resistive touch panel.

### SUMMARY OF THE INVENTION

Accordingly, the present invention has been devised to solve the above-mentioned problems, and the present invention intends to provide a resistive touch panel in which the contact resistance between transparent electrodes does not change in relation to the pressure intensity of input means because the transparent electrodes are cured by forming the transparent electrodes using a conductive polymer and then applying a curing agent thereto.

An aspect of the present invention provides a resistive touch panel, including: a transparent substrate; a transparent electrode formed on the transparent substrate and including a conductive polymer; and a curing agent applied to the transparent electrode, the curing agent undergoing a hydrolysis reaction with the conductive polymer to cure the transparent electrode, the curing agent being is represented by Formula 1 below:

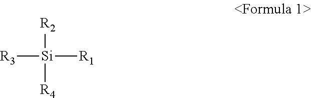

wherein R1, R2, R3 or R4 is an alkoxy group, a mercaptopropyl group, an aminopropyl group or a phosphate group.

Here, the curing agent, represented by Formula 1 above, may be represented by Formula 2 below:

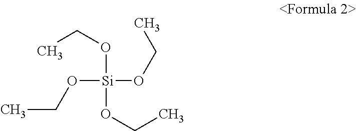

Further, the curing agent, represented by Formula 1 above, may be represented by Formula 3 below:

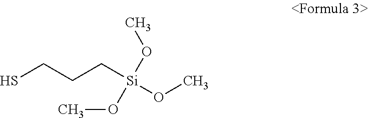

Further, the curing agent, represented by Formula 1 above, may be represented by Formula 4 below:

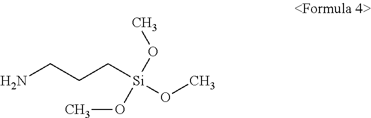

Further, the curing agent, represented by Formula 1 above, may be represented by Formula 5 below:

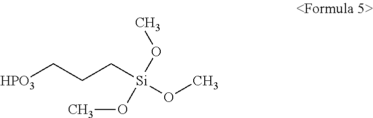

Further, the conductive polymer may include poly-3,4-ethylenedioxythiophene/polystyrenesulfonate (PEDOT/PSS), polyaniline, polyacetylene, and polyphenylenevinylene.

Further, an ionic liquid including an imidazolium salt serving to decrease a surface resistance of the transparent electrode may be applied to the transparent electrode.

Further, the curing agent may be applied to the transparent electrode by a spraying method.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a resistive touch panel according to an embodiment of the present invention; and

FIGS. 2 and 3 are sectional views, each showing a resistive touch panel according to another embodiment of the present invention.

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side,” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

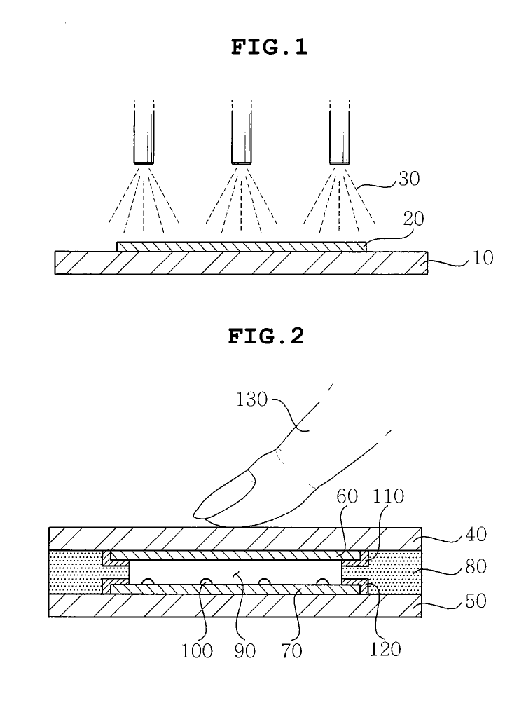

FIG. 1 is a sectional view showing a resistive touch panel according to an embodiment of the present invention.

As shown in FIG. 1, the resistive touch panel according to an embodiment of the present invention includes: a transparent substrate 10; a transparent electrode 20 formed on the transparent substrate 10 and including a conductive polymer; and a curing agent 30 applied to the transparent electrode 20, the curing agent 30 undergoing a hydrolysis reaction with the conductive polymer to cure the transparent electrode 20.

The transparent substrate 10 serves to provide a region for forming the transparent electrode 20 and electrode wires. Here, the transparent substrate 10 must have durability to support the transparent electrode 20 and the electrode wires and have transparency to allow users to recognize images transmitted from an image display apparatus. For the sake of durability and transparency, the transparent substrate 10 may be made of polyethylene terephthalate (PET), polycarbonate (PC), polymethylmethacrylate (PMMA), polyethylene naphthalate (PEN), polyether sulfone (PES), cycloolefin copolymer (COC), triacetylcellulose (TAC), polyvinyl alcohol (PVA), polyimide (PI), polystyrene (PS), K-resin-containing biaxially-oriented polystyrene (BOPS), glass, reinforced glass, or the like, but the present invention is not limited thereto.

Meanwhile, the transparent substrate 10 may be high-frequency-treated or primer-treated in order to activate one side thereof. When one side of the transparent substrate 10 is activated by high-frequency treatment or primer treatment, adhesion between the transparent substrate 10 and the transparent electrode 20 can be improved.

The transparent electrode 20, which serves to enable a controller to recognize touch coordinates by generating signals when input means touches them, is formed on the transparent substrate 10.

Here, the transparent electrode 20 may be formed using a composition including a conductive polymer, a solvent, a binder and a dispersion stabilizer.

The conductive polymer may include ethylenedioxythiophene/polystyrenesulfonate (PEDOT/PSS), polyaniline, polyacetylene, polyphenylenevinylene, and the like.

The solvent serves to dissolve a solute such as a conductive polymer, a binder or the like to make a solution, and one or more kinds of solvents may be used. For example, the solvent may be any one selected from aliphatic alcohols such as methanol, ethanol, iso-propanol, butanol and the like; aliphatic ketones such as acetone, methyl ethyl ketone and the like; aliphatic carboxylic acid esters; aliphatic carboxylic acid amides; aromatic hydrocarbons; aliphatic hydrocarbons; acetonitrile; aliphatic sulfoxides; water; and mixtures thereof.

The binder serves to adjust the viscosity of the composition itself and to improve adhesion between the transparent substrate 10 and the transparent electrode 20. Examples of the binder may include acrylic binders, epoxy-based binders, ester-based binder, urethane-based binders, carboxylic binders, amide-based binders, and the like.

As the dispersion stabilizer, ethylene glycol or the like may be used.

The transparent electrode 20 may be formed on the transparent substrate 10 by preparing a composition including a conductive polymer, a solvent, a binder and a dispersion stabilizer and then applying the composition onto the transparent substrate 10 using a dry process such as sputtering, evaporation or the like, a wet process such as dip coating, spin coating, roll coating, spray coating or the like, or a direct patterning process such as screen printing, gravure printing, ink-jet printing or the like. Subsequently, the transparent electrode 10 is dried at 50˜150° C. such that it has uniform conductivity, moisture resistance, heat resistance, durability and contraction stability.

The transparent electrode 20 including a conductive polymer, formed by the above process, is advantageous in that it has excellent flexibility and coatability. However, this transparent electrode 20 is problematic in that, since its hardness is relatively low, when two transparent electrodes facing each other come into contact with each other, the contact resistance between the two transparent electrodes changes in relation to the pressure intensity of input means. Therefore, in order to solve the above problem, as described later, the curing agent 30 is applied to the transparent electrode 20.

The curing agent 30 is applied onto the transparent electrode 20 and serves to cure the transparent electrode 20. Here, it is shown in FIG. 1 that the curing agent 30 is applied onto the transparent electrode 20 by a spraying method. However, the present invention is not limited thereto, and the curing agent 30 may be applied onto the transparent electrode 20 by a dipping method. Meanwhile, the curing agent 30 applied on the transparent electrode 20 takes part in a condensation reaction, attributable to a hydrolysis reaction of the curing agent 30 and the conductive polymer in the transparent electrode 20, to cure the transparent electrode 20. In this case, the curing agent is a silicon compound represented by Formula 1 below:

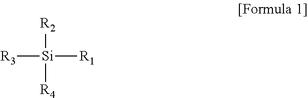

wherein R1, R2, R3 or R4 is an alkoxy group, a mercaptopropyl group, an aminopropyl group or a phosphate group.

Concretely, the curing agent 30 may be tetraethyl orthosilicate (TEOS) represented by Formula 2 below:

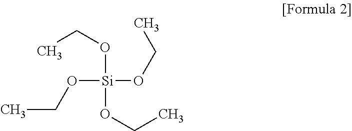

Further, the curing agent 30 may be 3-mercaptopropyl(trimethoxy)silane represented by Formula 3 below:

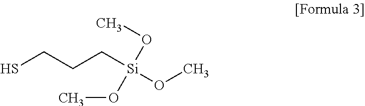

Further, the curing agent 30 may be 3-aminopropyl(trimethoxy)silane represented by Formula 4 below:

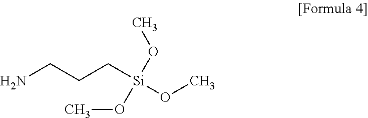

Further, the curing agent 30 may be a silicon compound having a phosphate group, represented by Formula 5 below:

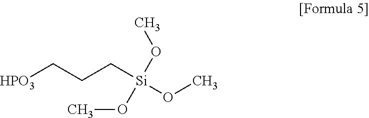

As described above, the transparent electrode 20 cured by the application of the curing agent 30 may further be dried in order to remove the curing agent 30 remaining therein and vaporize the water produced by the hydrolysis reaction.

Meanwhile, an ionic liquid may further be applied onto the transparent electrode 20 in order to decrease the surface resistance of the transparent electrode 20. In this case, the ionic liquid may include an imidiazolium salt.

The resistive touch panel according to this embodiment is advantageous in that the hardness of the transparent electrode 20 is improved by the application of the curing agent 30, so that it is possible to prevent the contact resistance between the transparent electrodes 20 facing each other from being changed depending on the pressure intensity of input means, thereby improving the touch sensitivity and performance of the resistive touch panel.

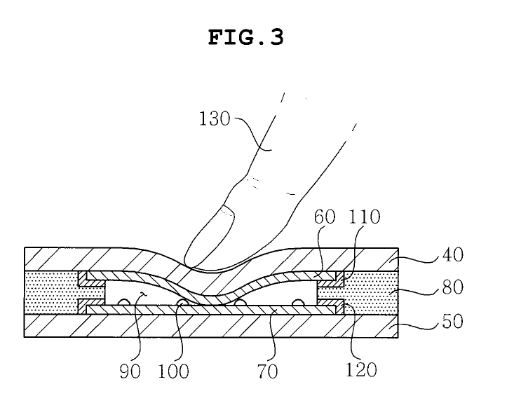

FIGS. 2 and 3 are sectional views, each showing a resistive touch panel according to another embodiment of the present invention.

As shown in FIGS. 2 and 3, a first transparent electrode 60 is formed on one side of a first transparent substrate 40, and a second transparent electrode 70 is formed on one side of a second transparent electrode 50, and then the edge of the first transparent substrate 40 and the edge of the second transparent electrode 50 are attached to each other by an adhesive layer 80 such as double-sided adhesive tape such that the first transparent electrode 60 and the second transparent electrode 70 face each other. In this case, an air gap 90 may be provided between the first transparent electrode 60 and the second transparent electrode 70, and dot spacers 100 may be provided on the first transparent electrode 60 or the second transparent electrode 70. Further, a first electrode wire 110 and a second electrode wire 120, which receive the electrical signals transmitted from the first transparent electrode 60 and the second transparent electrode 70, are respectively disposed at the edge of the first transparent substrate 40 and the edge of the second transparent electrode 50.

When input means 130 press the upper side of the first transparent substrate 40 (refer to FIG. 2), the first transparent substrate 40 warps toward the second transparent substrate 50 and simultaneously comes into contact with the second transparent substrate 50 (refer to FIG. 3). In this case, since each of the first transparent electrode 60 and the second transparent electrode 70 is coated with the curing agent 30, the hardness thereof is improved, and thus the contact resistance between the first transparent electrode 60 and the second transparent electrode 70 does not change in relation to the pressure intensity of the input means 130. Therefore, the resistive touch panel according to the present invention can realize excellent touch sensitivity and performance even when its transparent electrode is formed using a conductive polymer having relatively low hardness.

As described above, according to the resistive touch panel of the present invention, even when a transparent electrode is formed using a conductive polymer having low hardness, the hardness of the transparent electrode can be improved by applying a curing agent onto the transparent electrode. Further, the hardness of the transparent electrode is improved by the application of the curing agent, so that it is possible to prevent the contact resistance between the transparent electrodes facing each other from changing in relation to the pressure intensity of input means, thereby improving the touch sensitivity and performance of the resistive touch panel.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

What is claimed is:

1. A resistive touch panel, comprising:
a transparent substrate;
a transparent electrode formed on the transparent substrate and including a conductive polymer; and
a curing agent applied to the transparent electrode, the curing agent undergoing a hydrolysis reaction with the conductive polymer to cure the transparent electrode, the curing agent being represented by Formula 1 below: 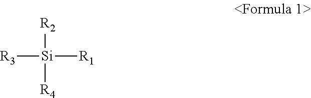
wherein R1, R2, R3 or R4 is an alkoxy group, a mercaptopropyl group, an aminopropyl group or a phosphate group.

2. The resistive touch panel according to claim 1, wherein the curing agent, represented by Formula 1 above, is represented by Formula 2 below:

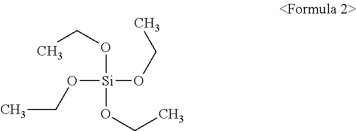

3. The resistive touch panel according to claim 1, wherein the curing agent, represented by Formula 1 above, is represented by Formula 3 below:

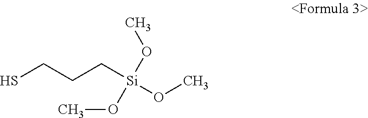

4. The resistive touch panel according to claim 1, wherein the curing agent, represented by Formula 1 above, is represented by Formula 4 below:

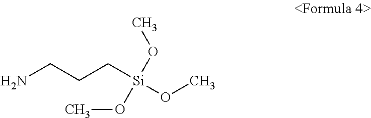

5. The resistive touch panel according to claim 1, wherein the curing agent, represented by Formula 1 above, is represented by Formula 5 below:

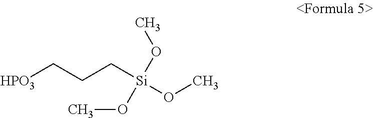

6. The resistive touch panel according to claim 1, wherein the conductive polymer includes poly-3,4-ethylenedioxythiophene/polystyrenesulfonate (PEDOT/PSS), polyaniline, polyacetylene, and polyphenylenevinylene.

7. The resistive touch panel according to claim 1, wherein an ionic liquid including an imidazolium salt serving to decrease a surface resistance of the transparent electrode is applied to the transparent electrode.

8. The resistive touch panel according to claim 1, wherein the curing agent is applied to the transparent electrode by a spraying method.
